(19) United States
(12) Patent Application Publication
(10) Pub. No.: US 2017/0292543 A1
(43) Pub. Date: Oct. 12, 2017

(54) Linear Displacement Sensor for Telescoping Cylinders and Actuators

(71) Applicant: Dragan Nikolic, Holiday, FL (US)

(72) Inventor: Dragan Nikolic, Holiday, FL (US)

(73) Assignee: Dragan Nikolic, Holiday, FL (US)

(21) Appl. No.: 15/626,124

(22) Filed: Jun. 18, 2017

(51) Int. Cl. F15B 15/28; G01D 5/16

(52) U.S. Cl. CPC F15B 15/2853; G01D 5/16; F16K 31/122

(57) ABSTRACT

A linear displacement sensor for telescoping cylinders, actuators, shock absorbers and dampers is disclosed. Said sensor being generally comprised of two parts-a contact and a resistor strip. The aforementioned invention having several embodiments: one embodiment having a contact disposed on the piston rod inside the cylinder and a resistor strip configured along the internal cylinder wall; another embodiment having a contact disposed at an outside end of the cylinder and the strip imbedded inside a groove along the piston rod. All embodiments including a plurality of insulated rod and wall groove shapes for said resistor strip. An object of the invention is to provide a means for measuring actuator displacement both inside and outside of an actuator.

### FIELD OF THE INVENTION

The present invention generally relates to telescoping cylinders. More specifically, this invention relates to linear displacement sensors operating on and within various types of telescoping cylinders—such as fluid, pneumatic and mechanical driven actuators and dampers, shock absorbers and the like.

BACKGROUND

Actuators were developed in the 1930s and are components that displace or control mechanisms in a linear fashion. They generally consist of a cylinder and rod that converts energy, generated by fluid and air (hydraulics and pneumatics), into mechanical motion. With the emergence of programmable logic controllers in the 1960s, actuators became increasingly popular within manufacturing industries to automate repetitive, linear motion tasks. Today, actuators can be found in most manufacturing environments. While actuators continue to improve and become more efficient, engineers have also begun to enhance actuator sensing capabilities to enhance their function. European Patent No. 0128881A2 Fjalgren disclosed a potentiometer that measures fluid displacement inside an actuator. The aforementioned patent does not utilize a linear resistor similar to the one disclosed in this specification. European Patent No. 3355690 granted to Djems disclosed a potentiometer for determining piston positions inside hydraulic actuators using a wire coil that is wrapped along the entire length of the actuator rod. U.S. Pat. No. 6,234,061B1 granted to Glassen disclosed a transducer attached to a pickup spool to detect actuator piston displacement. The aforementioned patent does not utilize a linear resistor similar to the one disclosed in the current specification. U.S. Pat. No. 6,588,313 granted to Brown et. al. disclosed a microwave pulse sensor to detect piston displacement inside a cylinder. Korean Patent Nos. 20090026442 and 20100108015A granted to Shik disclosed magnetic sensors to measure piston rod displacement on the exterior of an actuator cylinder. Once again, the aforementioned patent does not utilize a linear resistor similar to the one disclosed in the current specification. While these disclosures present various methods of measuring actuator displacement, few were found in the prior art that utilized linear resistors embedded within the internal actuator and shock absorber components.

### SUMMARY OF THE INVENTION

The device herein disclosed and described provides a solution to the shortcomings in the prior art through the disclosure of a linear displacement sensor for telescoping cylinders and actuators, including dampeners.

An object of the invention is to provide a means for measuring actuator and damper rod displacement. Measuring such displacement allows microcontrollers (not part of this invention) to interpret how far an actuator rod moves another component or mechanism. A linear resistor can generally be thought of as an electrical loop having a segment within said loop that generates a weaker signal as the loop is elongated. This loop represents the resistor-as one portion of the device travels along a path of another, the current changes allowing a controller to receive and interpret said current as rod distance away from the cylinder. A linear resistor sensor is generally made up of three parts: an electrical supply, a resistor strip (medium that an electrical current passes) and a contact (a metal protrusion with a spring and ball bearing or simply a prong that registers voltage from the strip). In some cases more than one contact may be used.

Another object of the aforementioned invention is to provide a linear resistor with an embodiment that utilizes an actuator rod as a base for the resistor strip. In this embodiment, the contact is positioned on the cylinder of an actuator and the resistor strip is embedded into the rod wall inside an insulated grooved section. A voltage is applied to the resistor strip and the contact measures the voltage gain or loss according to how far the strip travels on the rod. The linear resistor apparatus is then wired externally allowing for a connection to some form of external microcontroller.

Another object of the aforementioned invention is to provide an embodiment of a linear resistor that utilizes an internal actuator wall as a base for the resistor strip. In this embodiment, the contact is positioned on the actuator rod and the resistor strip is embedded into the rod wall inside an insulated, grooved section. Once again a voltage is applied to the resistor strip and the contact measures the voltage gain or loss according to how far the rod travels.

Another object of the aforementioned invention is to provide an embodiment of a linear resistor that utilizes a contact positioned on a side of an interior wall inside an actuator cylinder that prevents a piston from coining into contact with said contact during travel.

Another object of the invention is to provide a multitude of channel configurations to receive said resistor strip including a concave slot, a filleted slot, chamfered slot and dove tailed slot etc. These various insulated, groove designs allow for a multitude of strips to be utilized within the system to generate a range of current resistance depending upon the application. An insulating seal within the groove prevents the resistor from making direct contact with the rod to eliminate cross-conductivity with the metal rod.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as limitaitons.

### BRIEF DESCRIPTION OF THE FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 is a side, section view of the invention with spring lever contacts on an actuator.

FIG. 2 is a side, section view of the invention with spring ball contacts on an actuator.

FIG. 3 is a cross section view of the invention with a spring ball contact on a dampener.

FIG. 4 is a cross section view of the invention with a spring lever contact on a dampener.

FIG. 5 is a symbolic diagram showing an embodiment of the invention with relative positions.

FIG. 6 is a symbolic diagram showing an embodiment of the invention with relative positions.

FIG. 7 is a symbolic diagram showing an embodiment of the invention with relative positions.

FIG. 8 is a symbolic diagram showing an embodiment of the invention with relative positions.

FIG. 9 is a symbolic diagram showing an embodiment of the invention with relative positions.

FIG. 10 is a wiring diagram representation of FIG. 5.

FIG. 11 is a wiring diagram representation of FIG. 6.

FIG. 12 is a wiring diagram representation of FIG. 7.

FIG. 13 is a wiring diagram representation of FIG. 8.

FIG. 14 is a wiring diagram representation of FIG. 9.

FIG. 15 is a graph illustrating rod travel vs. volts/ohms.

FIG. 16 is a side, section view of the invention with spring ball contacts on an actuator rod.

FIG. 17 is a side, section view of the invention with lever spring contacts on a dampener.

FIG. 18 is a side, section view of the invention with spring lever contacts on a dampener.

FIG. 19 is a section view of a rod having embedded resistor strip in a square groove.

FIG. 20 is a section view of a rod having embedded resistor strip in a circular groove.

FIG. 21 is a section view of a rod having embedded resistor strip in a dovetail groove.

FIG. 22 is a section view of a rod having embedded resistor strip on the surface.

FIG. 23 is a wiring diagram representation of FIG. 27.

FIG. 24 is a wiring diagram representation of FIG. 28.

FIG. 25 is a wiring diagram representation of FIG. 29.

FIG. 26 is a wiring diagram representation of FIG. 30.

FIG. 27 is a symbolic diagram showing an embodiment of the invention.

FIG. 28 is a symbolic diagram showing an embodiment of the invention.

FIG. 29 is a symbolic diagram showing an embodiment of the invention.

FIG. 30 is a symbolic diagram showing an embodiment of the invention.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

FIG. 1 showing invention 1 having an embodiment comprised of an actuator 4 (such but not limited to, a hydraulic or pneumatic actuator) with at least, but not limited to, two spring lever contacts 9 disposed on an end of said actuator 4. Said contacts 9 disposed on each side of rod 3 and configured parallel with said rod 3's longitudinal axis allowing said contacts 9 levers to make contact with said rod 3. Actuator 4 having resistor strip 8 configured on said rod 3 parallel to its longitudinal axis. Said strip 8 affixed to said rod 3 by means of an adhesive such as epoxy and the like insulating the strip 8 from rod 3. Rod 3 positioned within actuator 4 by means of flexible seals 5 and 2 being made of a flexible material such as but not limited to rubber and the like. Said contact 9 being affixed to substrate by means of fasteners or adhesives and the like.

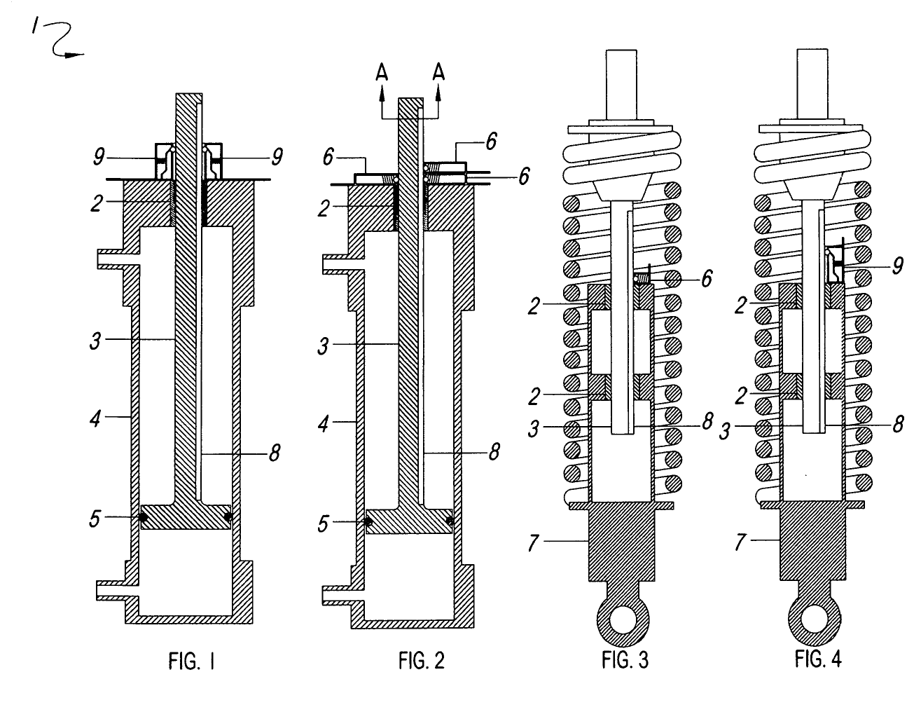

FIG. 2 showing invention 1 having an embodiment comprised of an actuator 4 (such but not limited to, a hydraulic or pneumatic actuator) with, but not limited to, three ball spring contacts 6 disposed on an end of said actuator 4. Said contacts 6 disposed on each side of rod 3 and configured perpendicular with said rod 3's longitudinal axis allowing said contacts 6 balls to make contact with said rod 3. Actuator 4 having resistor strip 8 also configured on said rod 3 parallel to its longitudinal axis. Said strip 8 affixed to said rod 3 by means of an adhesive such as epoxy and the like insulating the strip 8 from rod 3. Rod 3 positioned within actuator 4 by means of flexible seals 5 and 2 being made of a flexible material such as but not limited to rubber and the like. Said contact 6 being affixed to substrate by means of fasteners or adhesives and the like.

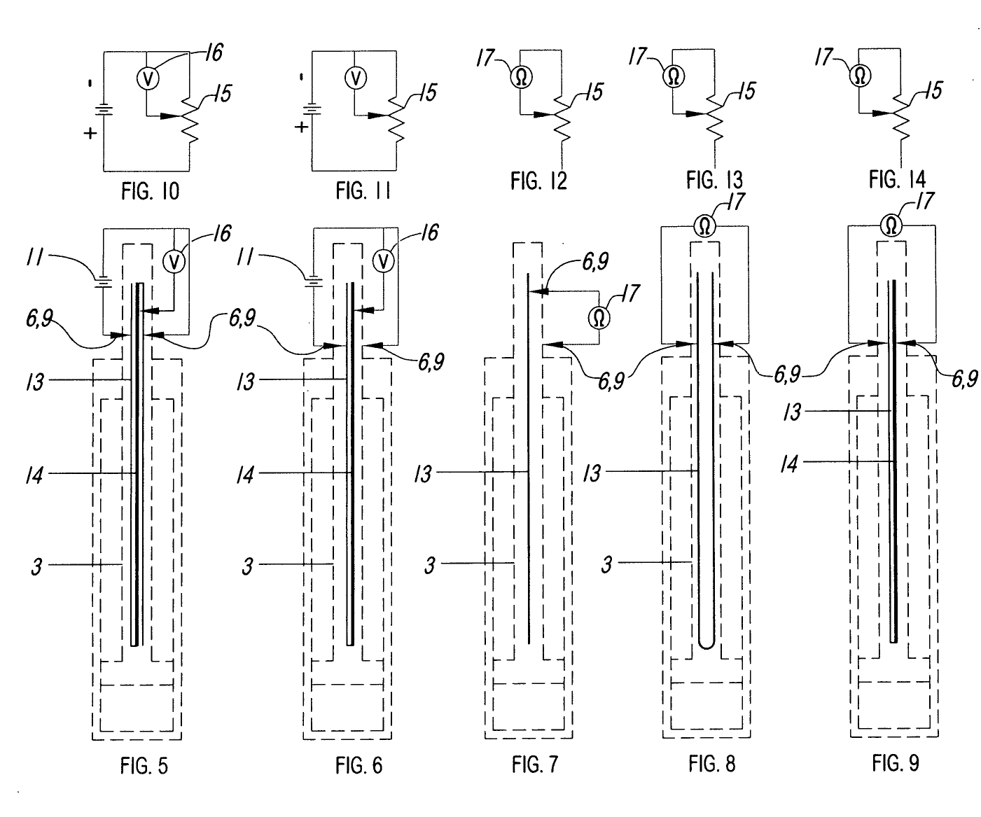

FIG. 3 showing invention 1 having an embodiment comprised of a strut dampener 7 with a ball spring contact 6 disposed on an end of said dampener 7 with at least, but not limited to, one ball spring contact 6 disposed on each side of rod 3 and configured perpendicular with said rod 3's longitudinal axis allowing said contact 6 balls to make contact with said rod 3. Dampener 7 having resistor strip 8 also configured on said rod 3 parallel to its longitudinal axis. Said strip 8 affixed to said rod 3 by means of an adhesive such as epoxy and the like insulating the strip 8 from rod 3. Rod 3 positioned within actuator 4 by means of flexible seals 2 being made of a flexible material such as but not limited to rubber and the like.

FIG. 4 showing invention 1 having an embodiment comprised of a strut dampener 7 with at least, but not limited to, one spring lever contact 9 disposed on an end of said dampener 7. Said contact 9 configured perpendicular with said rod 3's longitudinal axis allowing said contact 9 lever to make contact with said rod 3. Dampener 7 having resistor strip 8 also configured on said rod 3 parallel to its longitudinal axis. Said strip 8 affixed to said rod 3 by means of an adhesive such as epoxy and the like insulating the strip 8 from rod 3. Rod 3 positioned within actuator 4 by means of flexible seals 2 being made of a flexible material such as but not limited to rubber and the like.

FIG. 5 showing a symbolic diagram of invention 1 having an embodiment comprised of an actuator having two contact wires 13 running parallel to the longitudinal axis of said rod 3 and affixed to rod 3 by means of grooves and epoxy (similar to resistor strip 14 as mentioned) and the like and being connected to each end of resistor strip 14. Said contact wires 13 also being connected to power source 11 and voltmeter 16 outside of the actuator. Three contacts 6 or 9 being disposed outside of said actuator-two of which being in contact with two contact wires 13 and one contact 6 or 9 being in contact to resistor strip 14. Said contacts 9 or 6 being affixed to substrate by means of fasteners or adhesives and the like.

FIG. 6 showing a symbolic diagram of invention 1 having an embodiment comprised of an actuator having one contact wire 13 running parallel to the longitudinal axis of said rod 3 and affixed to rod 3 by means of grooves and epoxy and the like (similar to resistor strip 14 as mentioned) and being connected to one end of resistor strip 14. Said contact wires 13 also being connected to power source 11 and voltmeter 16 outside of the actuator. Three contacts 6 or 9 being disposed outside of said actuator-a first being in contact with contact wire 13, a second being in contact with metal rod 3 and a third being in contact with resistor strip 14. Said contacts 9 or 6 being affixed to substrate by means of fasteners or adhesives and the like.

FIG. 7 showing a symbolic diagram of invention 1 having an embodiment comprised of an actuator having resistor strip 14 running parallel to the longitudinal axis of said rod 3 and affixed to rod 3 by means of grooves and epoxy and the like. Said resistor strip 14 being in contact with said rod 3 conducting electricity between the two components. One contact 6 or 9 being in contact with said metal rod 3 and another contact 6 or 9 being in contact with said resistor strip 14. Said contacts 9 or 6 being affixed to substrate by means of fasteners or adhesives and the like.

FIG. 8 showing a symbolic diagram of invention 1 having an embodiment comprised of an actuator having resistor strip 14 running parallel to said rod 3 and being in contact with two contacts 6 or 9 at one end of said actuator.

FIG. 9 showing a symbolic diagram of invention 1 having an embodiment comprised of an actuator having resistor strip 14 and ground 13 running parallel to said rod 3-said strip 14 and ground 13 also being in contact with two individual contacts 6 or 9 at one end of said actuator.

FIG. 10 showing a wiring diagram of invention 1 having an electrical loop comprised of power source 11 (such as a battery or electrical outlet etc.), voltmeter 16 and resistor 15.

FIG. 11 showing a wiring diagram of invention 1 having an electrical loop comprised of power source 11 (such as a battery or electrical outlet etc.), voltmeter 16 and resistor 15.

FIG. 12 showing a wiring diagram of invention 1 having an electrical loop comprised of ohm meter 17 and resistor 15.

FIG. 13 showing a wiring diagram of invention 1 having an electrical loop comprised of ohm meter 17 and resistor 15.

FIG. 14 showing a wiring diagram of invention 1 having an electrical loop comprised of ohm meter 17 and resistor 15.

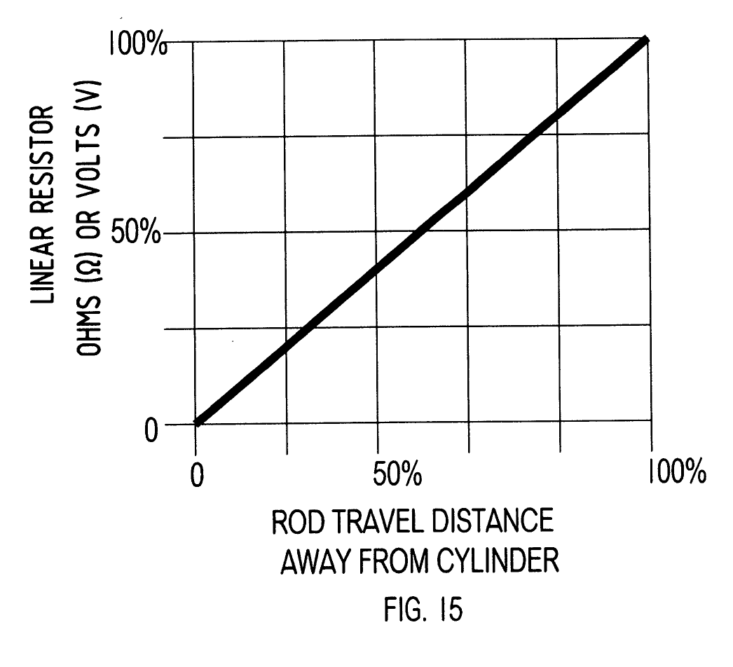

FIG. 15 showing a graph depicting how as rod distance increases from the actuator, cylinder ohms or volts increases on a linear resistor.

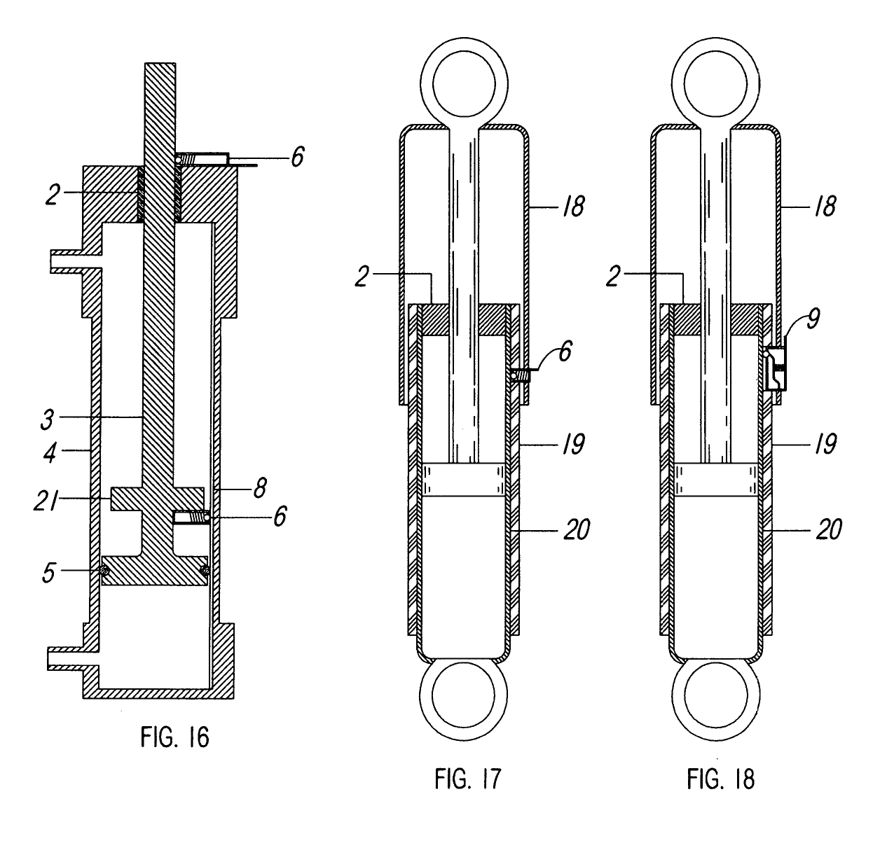

FIG. 16 showing invention 1 having an embodiment comprised of an actuator 4 (such but not limited to, a hydraulic or pneumatic actuator) with a single spring lever contact 6 disposed on an end of said actuator 4. Said contact 6 configured parallel with said rod 3's longitudinal axis allowing said contact 6 to make contact with said rod 3. Said contact 6 being affixed to substrate by means of fasteners or adhesives and the like. Actuator 4 having resistor strip 8 configured on internal wall of actuator 4 cylinder wall parallel to its longitudinal axis. Said strip 8 affixed to said wall by means of an adhesive such as epoxy and the like insulating the strip 8 from the wall. Rod 3 positioned within actuator 4 by means of flexible seals 5 and 2 being made of a flexible material such as but not limited to rubber and the like.

FIG. 17 showing invention 1 having an embodiment comprised of a conventional shock absorber with a an outer cylinder casing 18 having an aperture configured to receive spring ball contact 6 therein. Said spring ball 6 in contact with internal cylinder casing 20. Shock absorber also having seal 2 with aperture to receive piston rod made of a flexible material such as rubber and the like. Said contact 6 being affixed to substrate by means of fasteners or adhesives and the like and having spring ball extending through a slot configured along the entire longitudinal axis of sleeve 19 (comprised of a rigid, supportive plastic material) and making contact with said casing 20. Said contact 6 configured perpendicular with said casing wall 20s longitudinal axis allowing said contact 6 to make contact with said casing wall 20. Rod 3 positioned within actuator 4 by means of flexible seals 5 and 2 being made of a flexible material such as but not limited to rubber and the like.

FIG. 18 showing invention 1 having an embodiment comprised of a conventional shock absorber with a an outer cylinder casing 18 having an aperture configured to receive spring lever contact 9 therein. Said spring lever 9 in contact with internal cylinder casing 20. Shock absorber also having seal 2 with aperture to receive piston rod made of a flexible material such as rubber and the like. Said contact 6 being affixed to substrate by means of fasteners or adhesives and the like and having spring lever 9 extending through a slot configured along the entire longitudinal axis of sleeve 19 (comprised of a rigid, supportive plastic material) and making contact with said casing 20. Said contact 6 configured perpendicular with said casing wall 20s longitudinal axis allowing said contact 6 to make contact with said casing wall 20. Rod 3 positioned within actuator 4 by means of flexible seals 5 and 2 being made of a flexible material such as but not limited to rubber and the like.

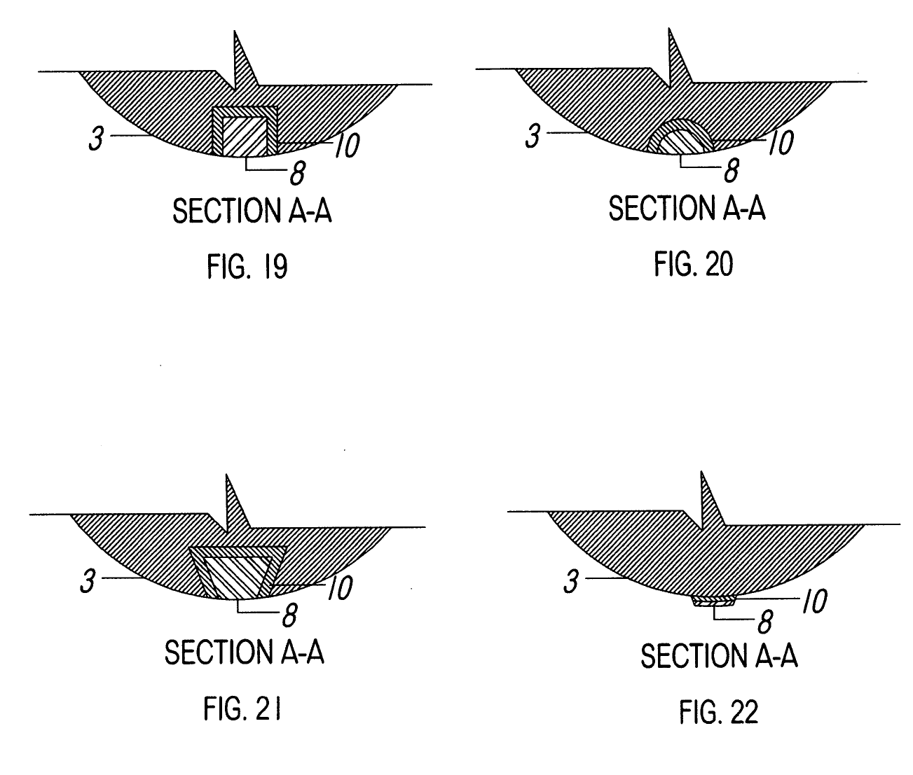

FIG. 19 showing a section view of rod 3 having a square-shaped groove configured to receive insulating adhesive 10 such as, but not limited to epoxy and the like as well as resistor strip 8 therewithin.

FIG. 20 showing a section view of rod 3 having a crescent-shaped groove configured to receive insulating adhesive 10 such as, but not limited to epoxy and the like as well as resistor strip 8 therewithin.

FIG. 21 showing a section view of rod 3 having a dovetail-shaped groove configured to receive insulating adhesive 10 such as, but not limited to epoxy and the like as well as resistor strip 8 therewithin.

FIG. 22 showing a section view of rod 3 having resistor srtip affixed directly to its surface by means of insulating adhesive 10 such as, but not limited to epoxy and the like.

FIG. 23 showing a wiring diagram of invention 1 having an electrical loop comprised of power source 11 (such as a battery or electrical outlet etc.), voltmeter 16 and resistor 15.

FIG. 24 showing a wiring diagram of invention 1 having an electrical loop comprised of power source 11 (such as a battery or electrical outlet etc.), voltmeter 16 and resistor 15.

FIG. 25 showing a wiring diagram of invention 1 having an electrical loop comprised of OHM meter 7 and resistor 15.

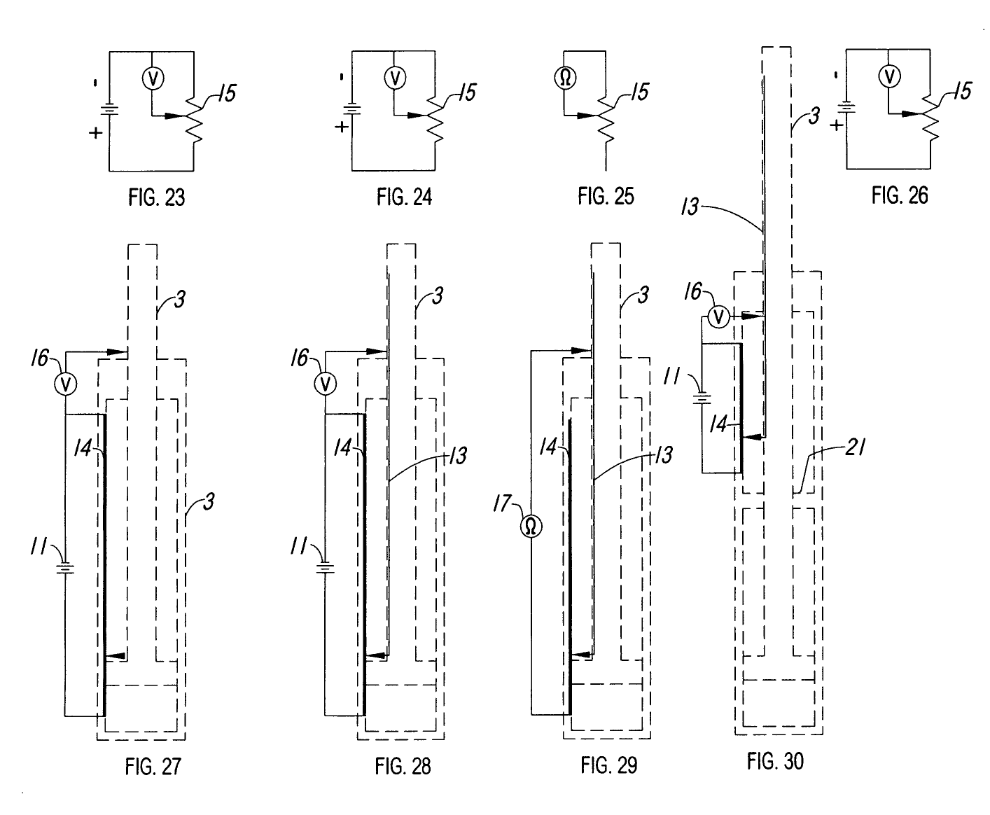

FIG. 26 showing a wiring diagram of invention 1 having an electrical loop comprised of power source 11 (such as a battery or electrical outlet etc.), voltmeter 16 and resistor 15.

showing a wiring diagram of invention 1 having an electrical loop comprised of OHM meter 7 and resistor 15.

FIG. 27 showing a symbolic diagram of invention 1 having an embodiment comprised of an actuator having a resistor strip 14 running parallel and affixed to the longitudinal axis of said cylinder wall by means of a groove and adhesive such as epoxy and the like. One contact 6 or 9 being disposed on inside rod 3 of said actuator and in contact with said strip 14 and another contact 6 or 9 being disposed outside of actuator in contact with conductive metal rod 3. Said contacts 9 or 6 being affixed to substrate by means of fasteners or adhesives and the like.

FIG. 28 showing a symbolic diagram of invention 1 having an embodiment comprised of an actuator having a resistor strip 14 running parallel and affixed to the longitudinal axis of said cylinder wall by means of a groove and adhesive such as epoxy and the like. One contact 6 or 9 being disposed on inside rod 3 of said actuator and in contact with said strip 14 and another contact 6 or 9 being disposed outside of actuator in contact with ground wire 13 on said rod 3. Said contacts 9 or 6 being affixed to substrate by means of fasteners or adhesives and the like.

FIG. 29 showing a symbolic diagram of invention 1 having an embodiment comprised of an actuator having an OHM meter 17 outside of said cylinder and a resistor strip 14 running parallel and affixed to the longitudinal axis of said cylinder wall by means of a groove and adhesive such as epoxy and the like. One contact 6 or 9 being disposed on inside rod 3 of said actuator and in contact with said strip 14 and another contact 6 or 9 being disposed outside of actuator in contact with ground wire 13 on said rod 3. Said contacts 9 or 6 being affixed to substrate by means of fasteners or adhesives and the like.

FIG. 30 showing a symbolic diagram of invention 1 having an embodiment comprised of an actuator having a volt meter 16 outside of said cylinder and a resistor strip 14 running parallel and affixed to the longitudinal axis of said cylinder wall by means of a groove and adhesive such as epoxy and the like.One contact 6 or 9 being disposed on inside rod 3 of said actuator and in contact with said strip 14 and another contact 6 or 9 being disposed outside of actuator in contact with ground wire 13 on said rod 3. Said contacts 9 or 6 being affixed to substrate by means of fasteners or adhesives and the like.

It is additionally noted and anticipated that although the device isimple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A linear displacement sensor for telescoping cylinders and actuators.

2. The linear displacement sensor of claim 1 providing a means for measuring actuator and damper rod displacement.

3. The linear displacement sensor of claim 1 providing a linear resistor with an embodiment that utilizes an actuator rod as a base for the resistor strip.

4. The linear displacement sensor of claim 1 providing an embodiment of a linear resistor that utilizes an internal actuator wall as a base for the resistor strip.

5. The linear displacement sensor of claim 1 providing a plurality of groove shapes for said resistor strip on cylinder walls and piston rods.

6. The linear displacement sensor of claim 1 providing a linear resistor that utilizes a contact positioned on a side of an interior wall inside an actuator cylinder that prevents a piston from coining into contact with said contact during travel.
